(19) United States
(12) Patent Application Publication
(10) Pub. No.: US 2026/0068799 A1
(43) Pub. Date: Mar. 12, 2026

(54) Coulter Holder for Agricultural Machines

(71) Applicant: Amazonen-Werke H. Dreyer SE & Co. KG, Hasbergen (DE)

(72) Inventors: Jens KOCH, Uelzen (DE); Jan-Eike LUEBBEN, Edewecht (DE); Sören BARTH, Schiffdorf (DE)

(73) Assignee: Amazonen-Werke H. Dreyer SE & Co. KG, Hasbergen (DE)

(21) Appl. No.: 19/118,422

(22) PCT Filed: Sep. 28, 2023
(86) PCT No.: PCT/EP2023/076824

§ 371 Date: Apr. 4, 2025

(30) Foreign Application Priority Data
Oct. 6, 2022 (DE) 102022125740.1

(51) Int. Cl. A01B 63/32; A01B 15/18; A01C 5/06

(52) U.S. Cl. CPC A01B 63/32; A01B 15/18; A01C 5/064

(57) ABSTRACT

A coulter holder having a frame connection for attaching to a machine frame and a coulter connection for attaching a coulter unit, wherein the coulter connection is pivotable relative to the frame connection between a working position and a raised position about a pivot axis via an actuating element and is lockable relative to the frame connection via a locking mechanism for fixing the coulter unit in the working position, wherein the locking mechanism is operatively connected to the actuating element and can be actuated by actuating the actuating element.

### CROSS REFERENCE TO RELATED APPLICATIONS

The present application claims priority under 35 U.S. C. § 365 to PCT/EP2023/076824 filed on Sep. 28, 2023 and under 35 U.S. C. § 119(a) to German Application No. 10 2022 125 740.1 filed on Oct. 6, 2022, both of which are incorporate by reference in their entireties.

### BACKGROUND

The disclosure relates to a coulter holder with a frame connection for attaching to a machine frame and a coulter connection for attaching a coulter unit, wherein the coulter connection can be pivoted about a pivot axis relative to the frame connection via an actuating element between a working position and a raised position and can be locked relative to the frame connection via a locking mechanism for fixing the coulter unit in the working position. A further object of the disclosure is a sowing machine with such a coulter holder.

Such coulter holders are used in agricultural machines, in particular soil tillage machines or sowing machines, and are used for attaching individual coulter units to a common machine frame. As a rule, several coulter units, which often have share-like tools for breaking up or loosening the soil of an agricultural area, are arranged transversely to a direction of travel next to each other at the rear end of the agricultural machine and are each connected to the machine frame via a coulter holder.

In a simple embodiment, such a coulter holder is configured in the manner of a mounting plate that is folded several times and has a frame connection for attaching to the machine frame on one side and a coulter connection for attaching the coulter unit on the other side. The attaching of the coulter holder to the machine frame and/or the coulter unit is usually done using detachable fastening elements such as screws or bolts.

Such a machine, which usually has numerous coulter units, is usually moved at a certain speed in the direction of travel along paths running essentially parallel to each other over the agricultural area for soil cultivation or sowing, for which purpose it can be attached to or mounted on agricultural towing machines, for example. The coulter units follow the agricultural towing machine, with the direction of travel corresponding to the direction of travel of the towing machine. In this way, parallel channel-or groove-like furrows can be created in the soil by means of the share-like tools of the coulter units, into which seeds can be placed for sowing or fertilizer can be applied. The number of coulter units arranged next to each other on the machine determines the number of furrows to be created.

In agricultural practice, it has proven to be a disadvantage that the furrow formation of a coulter unit is influenced by the two neighboring coulter units, in particular when the coulter units are arranged a short distance apart. The soil moved by a coulter unit is usually diverted transversely to the direction of travel on both sides, whereby it can collide with the soil moved by the neighboring coulter units and congestion can occur between the coulter units.

For this reason, it has proven to be advantageous if neighboring coulter units are arranged offset to each other in the direction of travel. In practice, extended coulter holders are used for this purpose, in which the distance between the frame connection and the coulter connection is increased in the direction of travel. With an alternating arrangement of short, plate-like and extended coulter holders, this results in an alternatingly offset arrangement of the coulter units on two lines, whereby the soil moved by the coulter units can be discharged unhindered to both sides and an improved passage of soil and organic material between the coulter units is also made possible.

In addition, it has proven advantageous in agricultural practice if individual coulter units can be deactivated, for example to avoid repeated tillage in overlapping paths or to realize different furrow spacings. Extended coulter holders are known from U.S. Pat. No. 11,166,402 B2, which have an additional pivoting functionality for pivoting the coulter unit. In these coulter holders, the coulter connection can be pivoted relative to the frame connection about a pivot axis via a hydraulic actuating element between a working position and a raised position. In its raised position, the respective coulter unit of such coulter holders is raised relative to the working surface and thus deactivated; in its lowered working position, the coulter unit is activated and ready for soil cultivation. Different configurations of the machines can thus be set, which are characterized by a different sequence of raised and lowered coulter units.

Depending on various influencing factors, such as the soil conditions or the driving speed, large forces act on the coulter units in the working position. These forces can lead to unintentional pivoting of the coulter connection on coulter holders with a pivoting function. This can lead to a change in the furrow depth and, in the worst case, even to the coulter unit lifting off the working surface, which can significantly impair the quality of soil cultivation or seed application. To prevent this problem, the coulter holders described in U.S. Pat. No. 11,166,402 B2 have a locking mechanism. Via this locking mechanism, the coulter connection can be locked in the working position relative to the frame connection, whereby a fixation of the coulter connection relative to the frame connection can be achieved. The locking mechanism is configured in the form of a spring-loaded locking hook, which must be actuated manually for unlocking.

In practice, such extended and pivoting coulter holders have generally proven their worth. However, it has proven to be a disadvantage in use in the field that the operating personnel, i.e. usually the driver of the towing machine, must first manually unlock the locking mechanism before the coulter connection can be pivoted relative to the frame connection via the actuating element. This results in a time-consuming, increased operating effort, particularly if there are a large number of coulter connections to be pivoted or if the configuration of the machine is changed frequently.

### SUMMARY

Against this background, the present disclosure is directed to providing a coulter holder in which the locking mechanism can be actuated in a user-friendly manner.

The locking mechanism is operatively connected to the actuating element and can be actuated by actuating the actuating element. This enables user-friendly and time-saving actuation of the locking mechanism via the actuating element. In this respect, the actuating element has a dual function. This is because it serves not only to pivot the coulter connection relative to the frame connection, but also to lock the coulter connection relative to the frame connection in the working position of the coulter unit.

In an advantageous further embodiment of the disclosure, it is proposed that the actuating element extends between a pivot bearing configured at the frame connection and a pivot bearing configured at the coulter connection. Such an arrangement enables a defined and reliable mounting of the actuating element. Furthermore, such an arrangement enables the coulter connection to be pivoted about the pivot axis in a simple manner relative to the frame connection by changing the length of the actuating element.

It is a constructive advantage if the pivot bearing arranged on the frame connection is mounted in a bearing guide so as to be movable, in particular movable transversely to the pivot axis, in particular movable between an upper stop and a lower stop of the bearing guide. Such a configuration allows the pivot bearing arranged on the frame connection an additional degree of freedom in the form of movability along the bearing guide in an advantageous manner. The additional mobility of the pivot bearing can be used to lock and unlock the coulter connection. The upper stop and the lower stop of the bearing guide can be used to easily limit the movability of the pivot bearing arranged on the frame connection. The stops can advantageously correspond to different positions of the locking mechanism. In particular, the upper stop can correspond to the locking position of the locking mechanism and/or the lower stop can correspond to an unlocking position of the locking mechanism.

Furthermore, it has proven to be advantageous if the locking mechanism has at least one locking lever that can be pivoted about a locking axis. Such a locking lever can be pivoted about the locking axis in a kinematically simple manner for locking and unlocking. Furthermore, a locking lever that can be pivoted about a locking axis allows one-sided actuation via the actuating element in an advantageously simple manner.

In this context, it is also proposed that the locking lever is connected on one side of the locking axis to the pivot bearing arranged on the frame connection via a lever bearing and has a locking element on the other side of the locking axis. Such a configuration enables defined rocking movements of the locking lever around the locking axis. In particular, the rocking movements can be limited by the stops of the bearing guide on the frame connection side. The rocking movements around the locking axis can enable secure actuation of the locking mechanism with advantageously low space requirements. Furthermore, the actuating forces to be applied via the actuating element can be low due to advantageous lever ratios.

In this context, it has proven to be constructively advantageous if the lever bearing and the locking element are arranged above the locking axis. The lever ratios resulting from such an arrangement make it possible to carry out rocking movements in a particularly simple and energy-saving manner.

In addition, it is proposed that a locking force acting on the locking element can be applied via the actuating element. The locking force acting on the locking element via the actuating element enables the coulter unit to be reliably locked against the frame connection. This enables reliable transmission of a defined coulter pressure to the coulter units even at high forward speeds, ensuring a constant furrow depth and thus a constant quality of seed output. In addition, such a locking force can prevent unintentional unlocking, for example due to vibrations or rocking in the working position, which can also ensure a continuous quality of soil cultivation.

An advantageous configuration of the locking element is that it is hook-shaped and can be locked to a locking bolt arranged on the coulter connection. Such a hook-shaped locking element enables a particularly reliable locking mechanism, whereby the locking bolt can be positively enclosed by the hook-shaped locking element for uniform transmission of the locking force, in particular over a wide circumferential range. Furthermore, such a hook-shaped locking element allows force transmission in several directions and thus increased security against the effects of shaking or vibration. If the recess of the hook-shaped locking element and the locking bolt are configured to correspond, a locking mechanism largely free of play can be achieved.

A further advantageous configuration provides for the locking bolt to be supported in the working position by a stop of a supporting bearing configured at the frame connection in order to absorb forces applied via the coulter unit. Such a stop of the supporting bearing enables the working position of the coulter unit to be adjusted in relation to the frame connection. This ensures that the coulter connection and thus the coulter unit can always be fixed in the same position relative to the frame connection with repeatable accuracy. Furthermore, such a stop can serve to avoid increased play and the associated wear.

In this context, it is proposed that the supporting bearing has a funnel-shaped guide area for inserting the locking bolt. Such a funnel-shaped guide area allows reliable insertion of the locking bolt. Furthermore, such a funnel-shaped guide area can be used to avoid undesirable tilting of the coulter units, which can occur in particular under one-sided loads, for example on slopes.

It is further proposed that the locking bolt extends transversely to a running direction of the coulter unit and has a locking region that interacts with the locking element and a supporting region that interacts with the supporting bearing. In such a configuration, the locking bolt has a dual function, which enables a configuration with an advantageously low number of parts.

In addition, it is proposed that the locking axis and the pivot axis extend essentially transversely to the running direction of the coulter unit, parallel to each other. This configuration makes it possible to avoid canting and/or tilting during locking and unlocking in an advantageously simple manner, resulting in a low-wear configuration with a low risk of failure. Alternatively, the locking axis and the pivot axis can also extend at an angle to the direction of travel of the coulter unit. Furthermore, arrangements of the locking axis and the pivot axis in which they do not extend parallel to each other are also conceivable.

Furthermore, it has proven to be advantageous if the pivot axis is arranged above the locking axis. This enables a favorable flow of force for securely fixing the coulter connection relative to the frame connection in the working position. In addition, such an arrangement enables improved accessibility of the locking mechanism. However, configurations are also conceivable in which the pivot axis can be arranged at the same height or below the locking axis.

In an advantageous further embodiment of the disclosure, a locking shaft extending along the locking axis is proposed, which is mounted on the frame connection in a torsion-proof manner via an anti-rotation device. Such a locking shaft enables defined pivoting movements of the locking element about the locking axis. The anti-rotation device can be used to achieve a configuration with as little play and wear as possible.

With regard to the locking lever, it is proposed that this is configured as a double lever. Such a double lever enables a particularly fail-safe and tilt-proof locking mechanism via two support points. Furthermore, a double lever has proven to be advantageous with regard to the symmetrical application of the connecting force.

It has also proven to be advantageous if the frame connection and the coulter connection each have a mounting region for detachable mounting on the machine frame and/or the coulter unit. Via such a mounting region a user-friendly mounting not prone to assembly errors of the frame connection and the coulter connection on the machine frame and/or the coulter unit can be enabled. Furthermore, such a configuration allows the frame connection and/or coulter connection to be replaced quickly and easily.

A configuration in which the pivot axis is arranged at an end of the coulter connection opposite the mounting region and the pivot bearing is arranged between the pivot axis and the mounting region has proven to be constructively advantageous. Such a configuration enables a kinematically advantageous pivoting of the coulter connection about the pivot axis over an advantageously large pivot angle range.

In this context, it is further proposed that a distance between the pivot bearing and the pivot axis is smaller than a distance between the pivot bearing and the mounting region. The resulting lever ratios enable a large pivot angle range with advantageously low force required for the pivot movements.

It has also proven to be advantageous if the mounting region of the frame connection at the frame connection is configured in a complementary manner to a mounting region of the machine frame and the mounting region of the coulter connection at the frame connection is configured in a complementary manner to a mounting region of the coulter unit. Such a configuration enables a particularly simple and user-friendly replacement of the coulter holder. Due to the complementary configuration of the mounting regions, the configuration of the agricultural machine can be adapted in a user-friendly and time-saving manner. In particular, coulter units can either be mounted directly on the machine frame or connected to the machine frame via the coulter holder. In addition, such a configuration allows the coulter holder to be used easily as a replacement/retrofit component for existing agricultural machines without the need for costly modifications to the machine frames of the machines.

It has also proven to be advantageous if the mounting regions are aligned essentially parallel to each other in the working position. This enables particularly simple and easy attachment of the coulter holder as well as good accessibility of the mounting regions. A vertical alignment of the mounting regions has proven to be particularly advantageous in this context. Alternatively, however, the mounting regions can also be aligned at an angle to one another if this should prove advantageous in the respective field of use.

In an advantageous further embodiment of the disclosure, it is proposed that the actuating element is configured as a hydraulic cylinder. Such a configuration of the actuating element enables the coulter connection to be pivoted quickly and precisely adjustable, in particular also steplessly, relative to the frame connection. Furthermore, large actuating forces for pivoting can be advantageously transmitted via an actuating element configured as a hydraulic cylinder. Alternatively, however, the actuating element can also be configured as a mechanical or electrical actuating element.

It has been found to be advantageous if the actuating element extends at an angle to the mounting region of the frame connection. Such an angled arrangement has proven to be advantageous with regard to pivoting the coulter connection with as little force as possible in relation to the frame connection over as large a pivot angle range as possible. It is particularly advantageous if the actuating element is arranged at an angle of less than 45 degrees, in particular less than 30 degrees, to the mounting region of the frame connection.

Furthermore, it is proposed that a weight force acting on the end of the actuating element on the coulter connection side in the working position is greater than a lever force acting on the end of the actuating element on the frame connection side. Such an arrangement makes it possible that when the actuating element is actuated in the working position, the locking mechanism is first unlocked before the coulter connection is pivoted relative to the frame connection. It is particularly advantageous if the weight force acting on the coulter connection side end of the actuating element results from the dead weight of the coulter unit. Such a locking mechanism based on the dead weight of the coulter unit has proven to be particularly reliable and low-wear. Furthermore, operating errors and resulting damage to the locking mechanism can be avoided, as the locking mechanism is always actuated automatically before the coulter connection is pivoted relative to the frame connection.

To solve the above problem, a sowing machine according to claim 13 is also proposed. In connection with the sowing machine, the same advantages previously mentioned in relation to the coulter holder arise. In particular, in such a sowing machine, the locking mechanisms of the respective coulter units can be actuated in a user-friendly and time-saving manner via the respective actuating element.

In connection with sowing machines, it is proposed that the coulter units have a parallelogram linkage for coulter pressure adjustment, the orientation of which does not change between the working position and the raised position. Such an arrangement has proven to be particularly user-friendly with regard to precise coulter pressure adjustment. Such a parallelogram linkage can be used to set uniform coulter pressures between the coulter units and the working surface, which can improve the uniformity of soil cultivation and, in particular, the quality of sowing.

Furthermore, a coulter pressure cylinder for adjusting the coulter pressure by changing the orientation of the parallelogram linkage is proposed in connection with the sowing machine. A coulter pressure cylinder of this type enables precise and repeatable adjustment of the coulter pressure in a user-friendly manner. The sowing machine can be adapted to a wide range of environmental influences, such as soil and weather conditions or seed varieties, by means of different coulter pressures. Furthermore, the coulter pressure cylinder can also be used to provide an additional option for lifting the respective coulter unit. It is particularly advantageous if the coulter pressure cylinder is configured as a hydraulic cylinder.

Furthermore, it is proposed that the sowing machine has several coulter units arranged transversely to the running direction parallel to each other, which are alternatingly attached directly to the machine frame or indirectly via a coulter holder to the machine frame. With such a configuration of the sowing machine, an improved passage of soil moved and/or organic material between the coulter units is possible, as these are arranged on two different lines transversely to the running direction on the machine frame. The neighboring coulter units do not influence each other in such an arrangement. Alternatively, several adjacent coulter units can also be arranged directly on the machine or attached to the machine frame via a coulter holder if this proves to be advantageous for the respective application situation. Instead of a direct arrangement, the coulter holders can also be attached to the machine frame via a short, plate-like coulter holder.

### BRIEF DESCRIPTION OF THE DRAWINGS

Further details and advantages of the disclosure are explained below with the help of the attached drawings according to FIGS. 1 to 9b. They show:

FIG. 1 shows perspective view of a sowing machine attached to an agricultural towing machine with a plurality of coulter units attached in two lines to a machine frame;

FIG. 2a and b show a side views of a coulter unit attached to a coulter holder of the prior art without pivoting function in a working position and a raised position;

FIG. 3a and b shows side views of a coulter holder according to the disclosure with pivoting function including a coulter unit attached thereto in a working position and a raised position;

FIG. 4 shows a perspective view of a coulter holder according to the disclosure in a working position;

FIG. 5 shows a view according to FIG. 4 with the frame connection and coulter connection separated from each other;

FIG. 6a shows a exploded view of a coulter holder according to the disclosure;

FIG. 6b shows an enlarged view of a detail according to FIG. 6a;

FIG. 7a A side view of a coulter holder according to the disclosure in a working position;

FIG. 7b shows a partially cut side view of a coulter holder according to the disclosure in an unlocked working position compared to the representation in FIG. 7a;

FIG. 8 shows a side view of a coulter holder according to the disclosure in a raised position;

FIG. 9a shows a side view of several adjacent coulter units in the working position, and

FIG. 9b shows a side view according to FIG. 9a with a coulter unit in the raised position.

### DETAILED DESCRIPTION

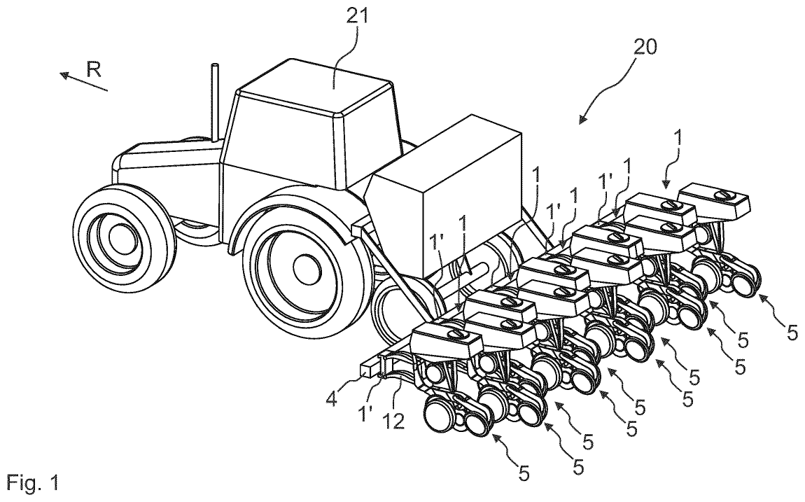

The illustration in FIG. 1 shows a perspective top view of a sowing machine 20 for sowing seed G on an agricultural area N. The sowing machine 20 is a machine for sowing seed G in single grain sowing, but it can alternatively also be a sowing machine 20 for volume sowing or a machine for sowing other, in particular granular material, such as fertilizer.

The sowing machine 20 is mounted to an agricultural towing machine 21, for example a tractor, and is pulled by it at a certain driving speed V along paths running essentially parallel to one another in one direction of travel over the agricultural area N for sowing. Alternatively, the sowing machine 20 can also be appended to the towing machine 21 or be self-propelled.

The sowing machine 20 according to FIG. 1 has a total of ten coulter units 5, which are arranged transversely to the direction of travel of the agricultural towing machine 21, which corresponds to the direction of travel R of the coulter units 5, next to each other at the rear end of the sowing machine 20. Depending on the equipment and area of application of the sowing machine 20, more or fewer coulter units 5 may also be provided.

The coulter units 5 have several tools, in particular chisel-like or share-like tools, for tearing up or loosening the soil in particular in order to prepare or follow up the sowing. A coulter unit 5 comprises at least one sowing coulter 13 for producing a channel-like furrow in the area N. Furthermore, devices and implements for depositing the seed G in the furrow and for closing the furrow after the seed G has been deposited in the soil of the area N can be provided in the coulter units 5.

According to the illustration in FIG. 1, the coulter units 5 are arranged alternatingly offset in two lines. In each case, five coulter units 5 are attached to the machine frame 4 via a comparatively short, plate-like coulter holder 1′. The other five coulter units 5 are attached to the machine frame 5 via a coulter holder 1 that is longer in the running direction R. The alternatingly offset arrangement of the coulter units 5 due to the coulter holders 1, 1′ of different lengths reduces the risk of soil moved and organic material accumulating between adjacent coulter units 5 and increases the passage of soil moved and organic material between the coulter units, which can increase the quality of the seed distribution.

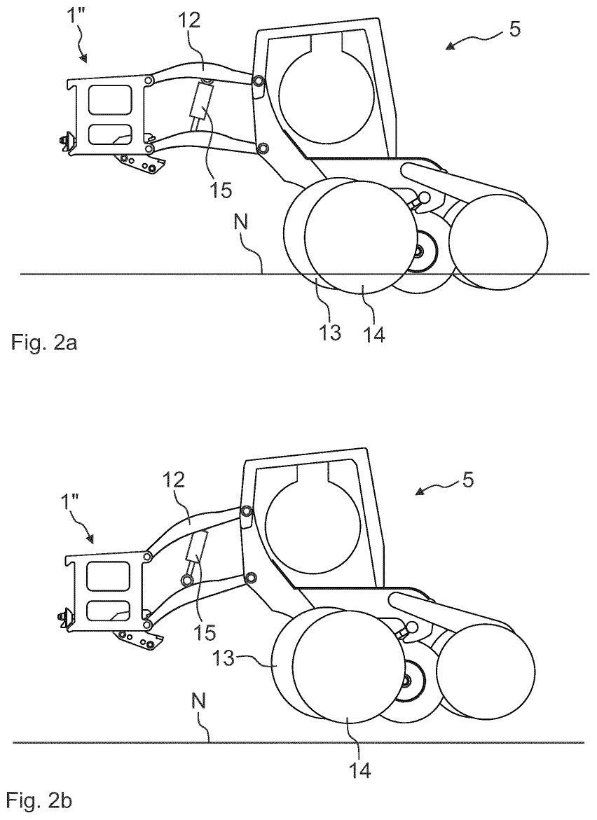

A parallelogram linkage 12 is provided in each case for guiding the coulter units 5 and for applying a coulter pressure D. The illustrations according to FIG. 2a and b each show a side view of a coulter unit 5, which is attached to the machine frame 4 (not shown in the illustrations according to FIG. 2a and b) via a longer coulter holder 1″ of the prior art, which is extended compared to the shorter coulter holders 1′. The parallelogram linkage 12 of the coulter unit 5 comprises a coulter pressure cylinder 15, via which a certain, adjustable coulter pressure D can be applied to the coulter unit 5. The coulter pressure D acting between the coulter 13 and the area N can be adjusted via the coulter pressure cylinder 15, whereby advantageous conditions for smooth running can be created even at increased travel speed V. To a limited extent, the coulter unit 5 can also be switched via the coulter pressure cylinder 15 between a lowered position (see FIG. 2a) and a position slightly raised relative to the area N (see FIG. 2b).

Based on such short and extended coulter holders 1′, 1″ of the prior art, coulter holders 1 according to the disclosure are proposed which have an additional pivoting functionality, which can be actuated via an actuating element 6, for pivoting the coulter unit 5 about a pivot axis A₁ as well as a locking mechanism 7 for locking the coulter unit 5 in its working position S₁. The locking mechanism 7 can be actuated in a user-friendly manner on such coulter holders 1.

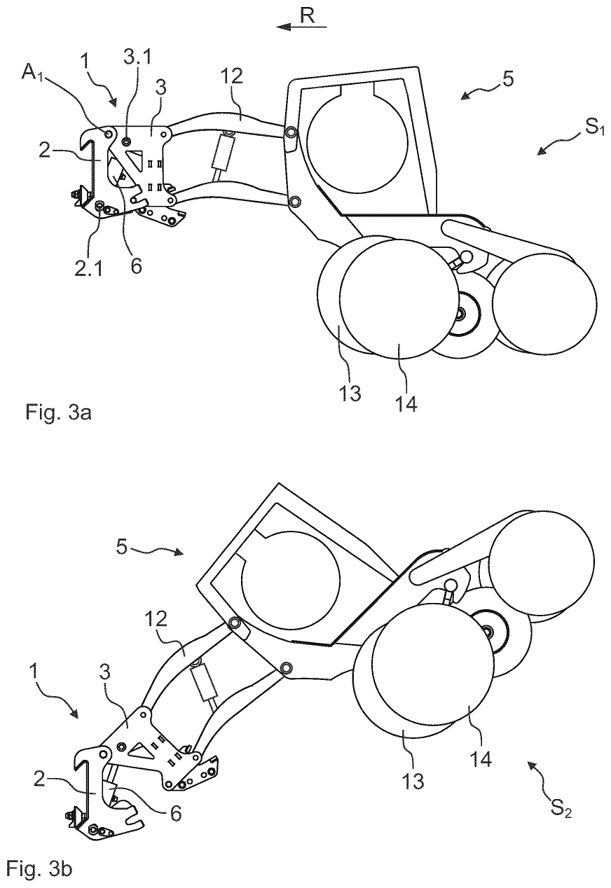

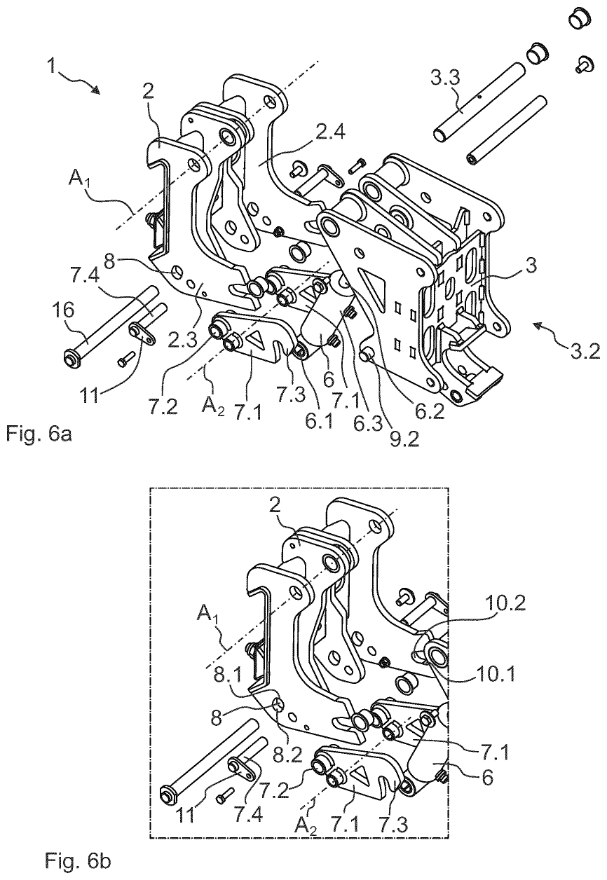

The pivoting function of the coulter holder 1 is explained below, primarily with reference to the illustration in FIGS. 3a-b. The coulter holder 1 has a frame connection 2 for attaching to a machine frame 4 and a coulter connection 3, which is operatively connected to the frame connection 2, for attaching a coulter unit 5. Both the frame connection 2 and the coulter connection 3 each have a mounting region 2.2, 3.2 for detachable mounting on the machine frame 4 and/or the coulter unit 5. The frame connection 2 and also the coulter connection 3 are each made of inter-connected sheet metal components in a space-saving and weight-saving manner, see FIG. 6a. The frame connection 2 has approximately two similar, multi-folded outer legs 2.3, 2.4, see e.g. FIG. 5. Similarly, the coulter connection 3 also has two sheet metal-like outer legs 3.4, 3.5, which are also multi-folded.

The coulter connection 3 can be pivoted about the pivot axis A₁ between a lowered working position S₁ (see FIG. 3a), which allows sowing, and a lifted raised position S₂ (see FIG. 3b). In the raised position S₂, the coulter unit 5 is deactivated, whereby in particular the sowing coulter 13, but also a support roller 14 carrying the coulter unit 5, have no contact with the area N. To pivot the coulter connection 3 relative to the frame connection 2, an actuating element 6 is provided, which extends between a pivot bearing 2.1 configured at the frame connection 2 and a pivot bearing 3.1 configured at the coulter connection 3, see FIG. 3b. The two pivot bearings 2.1, 3.1 can be configured in particular as radial or support bearings. The actuating element 6 is configured as a hydraulic cylinder, the cylinder tube 6.3 of which is connected to the pivot bearing 2.1 on the frame-connection side and the piston rod 6.2 of which is connected to the pivot bearing 3.1 on the coulter-connection side. Alternatively, the actuating element 6 can also be configured as a mechanical, for example spindle-like actuating element 6 or as a servomotor or can also be arranged in a different orientation between the pivot bearings 2.1, 3.1.

As the comparison of the illustrations in FIGS. 3a and 3b show, the coulter connection 3 can be pivoted relative to the frame connection 2 by changing the length of the actuating element 6. The lowered working position S₁ is present in the short starting position of the actuating element 6 and the fully raised position S₂ is present in the extended end position of the actuating element 6. Depending on the position of the actuating element 6, various intermediate positions can be moved to between the lowered working position S₁ and the lifted raised position S₂, which differ in terms of a different raised position and a different pivot angle.

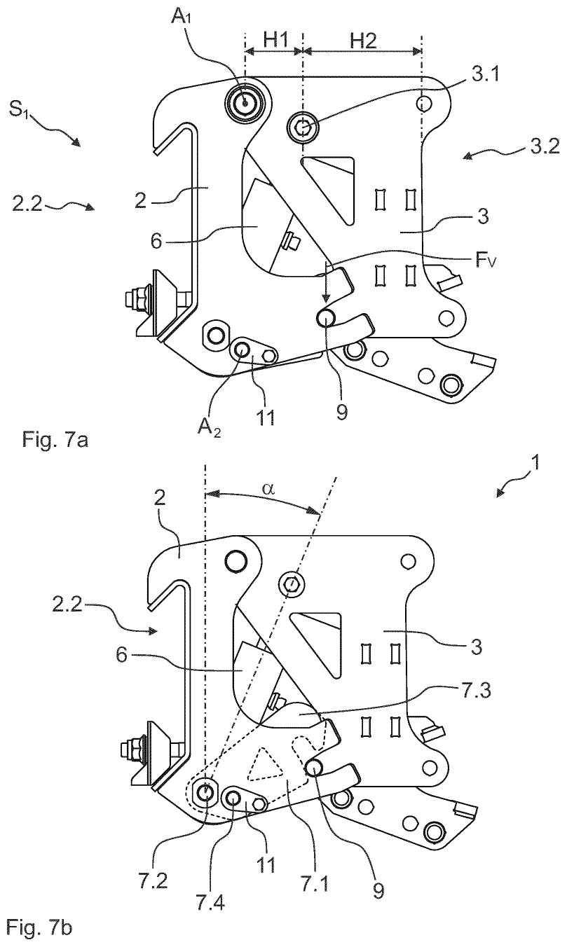

The pivot axis A₁ is arranged at an end of the coulter connection 3 opposite the mounting region 3.2, see FIG. 3a. The pivot bearing 3.1 is arranged between the pivot axis A₁ and the mounting region 3.2. The distance H₁ between the pivot bearing 3.1 and the pivot axis A₁ is smaller than the distance H₂ between the pivot bearing 3.1 and the mounting region 3.2, see also FIG. 7a. As a result, an advantageously large controllable pivot angle range can be achieved. With a comparatively small stroke of the actuating element 6, the coulter connection 3 can be pivoted through a comparatively large pivot angle due to this arrangement.

The configuration described above shows that the actuating element 6 extends at an angle α relative to the mounting region 2.2 of the frame connection 2, see also FIG. 7b. Comparatively small angles α, i.e. a rather steep arrangement of the actuating element, result in favorable force ratios. In particular, the smaller the angle α, the lower the transverse forces acting on the actuating element 6 transversely to its actuating direction. Furthermore, with such a steep alignment, the piston rod 6.2 of the actuating element 6 does not need to be moved as far out of the cylinder tube 6.3 to reach the raised position S₂ as is the case with a flatter alignment. However, a flatter alignment can also be advantageous as an alternative, for example with regard to a particularly finely adjustable setting of the raising of the coulter unit 5.

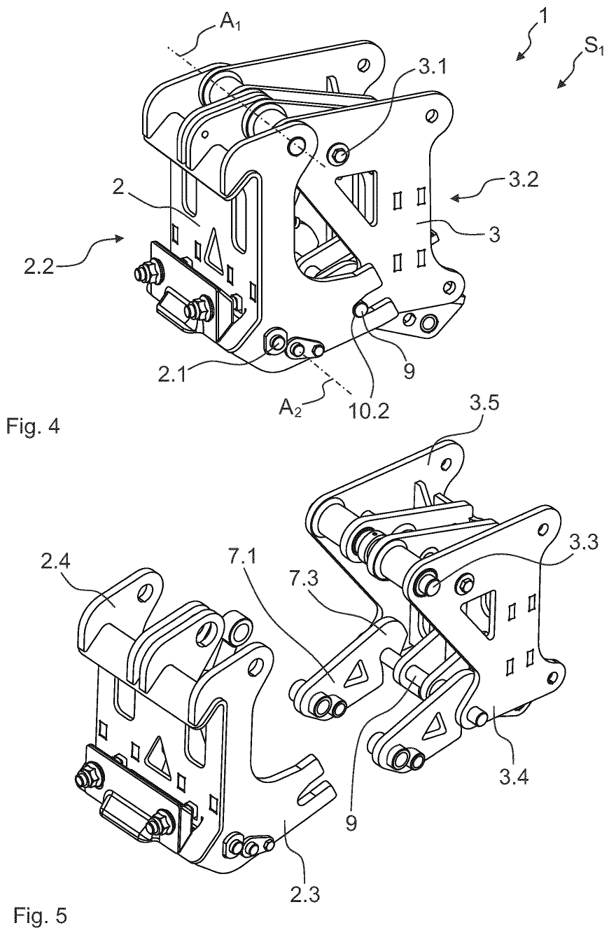

In the following, the illustrations in FIGS. 4 and 5 are used to explain not only the structure of the coulter holder 1 with regard to the above-mentioned pivoting function about the pivot axis A₁, but also the locking mechanism 7, which can be used to fix the coulter connection 3 in the working position S₁ relative to the frame connection 2.

As can be seen from FIG. 4, the pivot axis A₁ extends along a pivot shaft 3.3, which is configured at the coulter connection 3 at its end opposite the mounting region 3.2. The pivot shaft 3.3 is inserted through corresponding bearing bushes of the coulter connection 3 and through corresponding bores of the frame connection 2, see in particular the exploded view according to FIG. 6a.

The locking mechanism 7 for locking the coulter connection 3 relative to the frame connection 2 in the working position S₁ has a locking lever 7.1 configured as a double lever, see FIG. 6a, which can be pivoted about a locking axis A₂. The locking lever 7.1, configured as a double lever, has a bore for receiving a locking shaft 7.4, along which the locking axis A₂ extends and which is mounted on the frame connection 2 in a torsion-proof manner via an anti-rotation lock 11. The locking lever 7.1 is connected on one side of the locking axis A₂ to the pivot bearing 2.1 arranged on the frame connection 2 via a lever bearing 7.2 and has a locking element 7.3 on the other side of the locking axis A₂. The lever bearing 7.2, the locking element 7.3 and the locking axis A₂ form a triangle, with the locking axis A₂ being arranged below an imaginary connecting line of the lever bearing 7.2 and the locking element 7.3. The locking lever 7.1 is configured in the manner of a rocker, wherein the lever bearing 7.2 and the locking element 7.3 can be moved in a rocking motion in opposite directions about the locking axis A₂.

The locking element 7.3 is hook-shaped and can be locked to a locking bolt 9 arranged on the coulter connection 3. For this purpose, the hook-shaped locking element 7.3 has a recess whose diameter is selected in such a way that the locking element 7.3 can enclose the locking bolt 9 in the working position S₁ essentially free of play, see FIG. 5. This enables both secure and reliable as well as low-wear locking.

In order to transmit the locking force F_{V} as evenly as possible, the two components of the locking lever 7.1, which is configured as a double lever, are arranged at a distance from each other in such a way that their two locking elements 7.3 can be locked to the locking bolt 9 in the area of the two outer ends of the latter, see FIG. 5. The actuating element 6 is arranged between the two components of the locking lever 7.1, which is configured as a double lever, see FIG. 6a. Alternatively, a configuration with a single locking lever 7.1 and correspondingly only one locking element 7.3 is also conceivable, which can be arranged in a central area of the coulter holder 1, for example. A higher number of locking levers 7.1 is also conceivable.

The way in which the locking mechanism 7 can be actuated by actuating the actuating element 6 is explained below. As already explained above, the locking lever 7.1 is connected to the pivot bearing 2.1 arranged on the frame connection 2 via the lever bearing 7.2 on the side opposite the locking element 7.3, see also FIG. 3a. A shaft 16 is provided for this purpose, which extends essentially parallel to the pivot axis A₁ through the two outer legs 2.3, 2.4 of the frame connection 2, the lever bearings 7.2 of the locking lever 7.1, which is configured as a double lever, and a bearing bore 6.1 of the actuating element 6 on the cylinder tube side. The pivot bearing 2.1, via which the actuating element 6 is also connected to the frame connection 2, is movably mounted in a bearing guide 8 transversely to the pivot axis A₁. The bearing guide 8 has a contour and is configured in the form of an elongated hole extending transversely to the pivot axis A₁, see FIG. 6b. Alternatively, the bearing guide 8 can also be configured as a groove or recess. The pivot bearing 2.1 is movable in the bearing guide 8 between an upper stop 8.1 and a lower stop 8.2, the corresponding stops 8.1, 8.2 being formed by the walls of the short ends of the bearing guide 8, which is configured as an elongated hole, see FIG. 6b.

In the working position S₁, in which the coulter connection 3 is locked relative to the frame connection 2, the actuating element 6 is in its short, retracted position and the pivot bearing 2.1 and thus also the lever bearing 7.2 are in contact with the upper stop 8.1 of the bearing guide 8. In accordance with the rocker functionality, the other end of the locking lever 7.1 is in its lower position, in which the hook-shaped locking element 7.3 is locked to the locking bolt 9 of the coulter connection 3, see FIGS. 4 and 5.

In the following, an unlocking sequence of the locking mechanism 7 and a pivoting of the coulter connection 3 out of the working position S₁ is explained primarily with reference to the illustrations in FIGS. 4-8.

In the working position S₁, the actuating element 6 is in its retracted position. When the actuating element 6 is actuated, the piston rod 6.2 is moved out of the cylinder tube 6.3 and the length of the actuating element 6 increases. The pivot bearing 2.1 in the bearing guide 8 is moved from the upper stop 8.1 in the direction of the lower stop 8.2 in accordance with the change in length of the actuating element 6. The lever bearing 7.2 of the locking lever 7.1, which receives the pivot bearing 2.1, follows this movement, causing the locking lever 7.1 to perform a pivoting movement around the locking axis A₂ in the manner of a rocker, see FIG. 6a. Due to the pivoting movement, the hook-shaped locking element 7.3 arranged at the other end of the locking lever 7.1 is also moved, namely in a direction of movement opposite to the movement of the lever bearing 7.2. As shown in FIG. 5, the locking element 7.3 pivots upwards and disengages from the locking bolt 9. The coulter connection 3 is thus unlocked. As the locking mechanism 7 is operatively connected to the actuating element 6, such a configuration is also less susceptible to malfunctions compared to a configuration in which the locking mechanism 7 can be actuated separately.

As soon as the pivot bearing 2.1 rests against the lower stop 8.2 of the bearing guide 8 as a result of the extension movement of the actuating element 6, the movement of the locking lever 7.1 ends. When the actuating element 6 is extended further by moving out the piston rod 6.2, the pivot bearing 3.1 is now moved. As a result, the coulter connection 3 can be pivoted about the pivot axis A₁, counterclockwise as shown in FIG. 3a and b. In the maximum extended position of the piston rod 6.2, the raised position S₂ of the coulter unit 5 attached to the coulter connection 3 is present.

In the present configuration, a weight force F_{G} acting on the end of the actuating element 6 on the coulter connection side in the working position S₁ is greater than a lever force F_{H} acting on the end of the actuating element 6 on the frame connection side. For this reason, the end of the actuating element 6 on the frame connection side moves first, which actuates the locking mechanism 7. This results in a sequential movement sequence.

An opposite pivoting of the coulter connection 3 out of the raised position S₂ and a locking sequence of the locking mechanism 7 are explained below.

In the raised position S₂, the actuating element 6 is in its extended position. When the actuating element 6 is actuated, the piston rod 6.2 is moved into the cylinder tube 6.3 and the length of the actuating element 6 is reduced. The pivot bearing 3.1 is moved in accordance with the change in length of the actuating element 6 and the coulter connection 3 performs a pivoting movement, which takes place in a clockwise direction as shown in FIG. 3b. The pivoting movement ends as soon as the coulter connection 3 rests against the frame connection 2.

If the actuating element 6 is shortened further, the pivot bearing 2.1 is now moved in the bearing guide 8, namely from the lower stop 8.2 towards the upper stop 8.1. The lever bearing 7.2 of the locking lever 7.1, which is connected to the pivot bearing 2.1, follows this movement, causing the locking lever 7.1 to perform a pivoting movement around the locking axis A₂ in the manner of a rocker. Due to the pivoting movement, the hook-shaped locking element 7.3 arranged at the other end of the locking lever 7.1 is also moved, namely in a direction of movement opposite to the movement of the lever bearing 7.2. Accordingly, the locking element 7.3 pivots downwards and comes into engagement with the locking bolt 9. The coulter connection 3 is thus locked with respect to the frame connection 2.

In the working position S₁, a locking force FV acting on the locking element 7.3 can be applied via the actuating element 6, see FIG. 7a. This locking force F_{V} acting between locking element 7.3 and locking bolt 9 ensures a reliable locking mechanism. Furthermore, the locking force F_{V} can be used to ensure that the locking mechanism 7 does not come loose undesirably, for example as a result of shaking loads or vibrations. The locking force F_{V} can also be used to ensure that sufficient coulter pressure D can be transmitted to the coulter units 5.

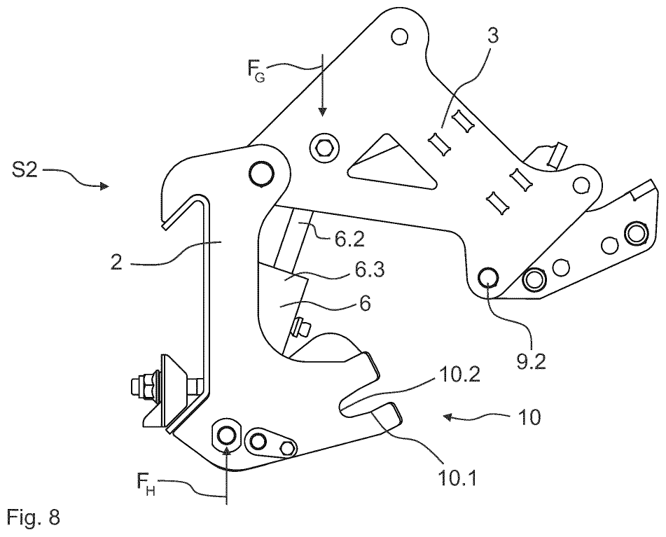

The frame connection 2 has a supporting bearing 10 with a stop 10.2 for supporting a supporting region 9.2 of the locking bolt 9 in the working position S₁, see FIG. 8. The supporting bearing 10 is configured as a double bearing at the lateral legs 2.3, 2.4, is formed to correspond to the locking bolt 9 and is used to absorb the forces applied via the coulter unit 5 and the coulter connection 3. The stop 10.2 can be used to ensure that the coulter connection 3 can always be fixed in the same position relative to the frame connection 2 with repeat accuracy.

The supporting bearing 10 also has a funnel-shaped guide area 10.1 for inserting the locking bolt 9. When the supporting region 9.2 of the locking bolt 9 arranged at the coulter connection 3 approaches the supporting bearing 10 as a result of pivoting of the coulter connection 3, the guide area 10.2 ensures reliable guidance into the working position S₁. Canting or tilting, which can occur in particular under the increased load of the coulter unit 5 and/or on uneven ground, can thus be avoided. The guide area 10.2 and, in particular, the supporting bearing 10 can be used to ensure that the coulter connection 3 and the frame connection 2 are in the relative position to each other required for the locking mechanism.

The locking bolt 9 performs a dual function. Together with the hook-shaped locking element 7.3, it ensures that the coulter connection 3 is locked in relation to the frame connection 2. At the same time, the locking bolt 9 also rests against the stop 10.2 of the guide area 10 in the working position S₁ and thus ensures correct positioning of the coulter connection 3 in relation to the frame connection 2.

In the following, constructive details of the coulter holder 1, in particular with regard to the arrangement of the pivot and locking axes A₁, A₂, are explained with reference to the illustrations in FIG. 7a and b.

As can be seen from the illustration in FIG. 7a, the pivot axis A₁ is arranged above the locking axis A₂, which results in favorable force ratios when the coulter connection 3 pivots relative to the frame connection 2. Alternatively, however, the pivot axis A₁ can also be arranged below the locking axis A₂.

It can also be seen in FIG. 7a that the distance H₁ between the pivot bearing 3.1 and the pivot axis A₁ is smaller than a distance H₂ between the pivot bearing 3.1 and the mounting region 3.2 of the coulter connection 3. The closer the point of engagement of the actuating element 6 is to the pivot bearing 3.1, the greater the possible lift with the same actuating element 6. The angle α between the actuating element 6 and the mounting region 2.2 of the frame connection is comparatively small and is less than 45 degrees, preferably less than 30 degrees. This results in favorable lever ratios and advantageously low transverse forces acting on the actuating element 6. Alternatively, however, other distance and angle ratios are also conceivable.

The mounting region 2.2 of the frame connection 2 and the mounting region 3.2 of the coulter connection 3 are essentially parallel and vertically aligned to each other in the working position S₁, see FIG. 7a. Furthermore, the mounting region 2.2 of the frame connection 2 is configured complementary to a mounting region of the machine frame 4 and the mounting region 3.2 of the coulter connection 3 is configured complementary to a mounting region of the coulter unit 5. This results in increased flexibility, as the respective coulter units 5 of a sowing machine 20 can be attached to the machine frame 4 either directly or via plate-like, short coulter holders, or via extended, pivoting coulter holders 1. This allows the sowing machine 20 to be configured flexibly. In particular, the coulter units 5 can be alternatingly attached to the machine frame 6 via short and long coulter holders 1, see FIG. 1. Such a configuration with an arrangement of the coulter units 5 in two lines results in an advantageously low interference of adjacent coulter units 5. In particular, in such a configuration there can be an axial offset between the two lines of about 200 mm.

The offset coulter units 5 cause different contact forces at the same measuring points, which is why a comparative contact force measurement, e.g. on the respective coulter holder 1 or on the machine frame 4, can be used to draw conclusions about the alignment of the respective coulter units 5. Since the alignment of the coulter units 5 is an important influencing factor for uniform seed placement and thus good sowing quality, the detection of the alignment of the coulter units 5 via the contact force measurement offers a way of checking the sowing quality. The detection of the contact force for detecting the alignment of the coulter units 5 can, for example, be integrated into a control system for hydraulic compensation of deviations in alignment.

Furthermore, the complementary configuration of the mounting regions 2.2, 3.2 allows simple, user-friendly retrofitting of the coulter holders 1 to existing sowing machines 20. No complex modification of the machine frame 4 of the sowing machines 20 is required.

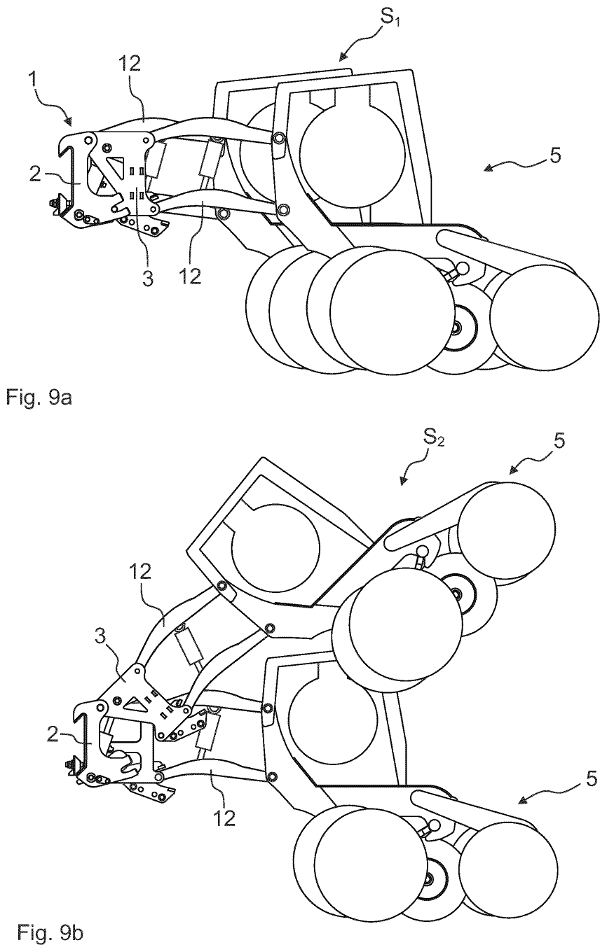

In addition, such an arrangement makes it possible to pivot half of the coulter units 5, which are connected to the machine frame 6 via the extended, pivoting coulter holders 1, into the raised position S₂ and thus deactivate them, see FIG. 9b. Compared to the configuration shown in FIG. 9a, half of the coulter units 5 are thus out of operation. Sowing takes place with a double spacing between the furrows or seed rows, which can prove to be advantageous for special seed G.

The coulter holder 1 described above and the sowing machine 20 are characterized by the fact that the locking mechanism 7 is operatively connected to the actuating element 6 and can be actuated by actuating the actuating element 6. This enables user-friendly and time-saving actuation of the locking mechanism 7 via the actuating element 6.

### REFERENCE SIGNS

1 Coulter holder
1′ Coulter holder
1″ Coulter holder
2 Frame connection
2.1 Pivot bearing
2.2 Mounting region
2.3 Leg
2.4 Leg
3 Coulter connection
3.1 Pivot bearing
3.2 Mounting region
3.3 Pivot shaft
3.4 Leg
3.5 Leg
4 Machine frame
5 Coulter unit
6 Actuating element
6.1 Bearing bore
6.2 Piston rod
6.3 Cylinder tube
7 Locking mechanism
7.1 Locking lever
7.2 Lever bearing
7.3 Locking element
7.4 Locking shaft
8.1 Stop
8.2 Stop
9 Locking bolt
9.1 Locking region
9.2 Supporting region
10 Supporting bearing
10.1 Guide area
10.2 Stop
11 Anti-rotation lock
12 Parallelogram linkage
13 Seed coulter
14 Support roller
15 Coulter pressure cylinder
16 Shaft
20 Sowing machine
21 Towing machine
A₁ Pivot axis
A₂ Locking axis
D Coulter pressure
F_{G} Weight force
F_{H} Lever force
F_{V} Locking force
G Seed
H₁ Distance
H₂ Distance
N Area
R Running direction
S₁ Working position
S₂ Raised position
V Travel speed
α Angle

1. A coulter holder having a frame connection for attaching to a machine frame and a coulter connection for attaching a coulter unit, wherein the coulter connection is pivotable relative to the frame connection about a pivot axis via an actuating element between a working position and a raised position and is lockable relative to the frame connection via a locking mechanism for fixing the coulter unit in the working position wherein the locking mechanism is operatively connected to the actuating element and can be actuated by actuating the actuating element.

2. The coulter holder according to claim 1, wherein the actuating element extends between a pivot bearing configured at the frame connection and a pivot bearing configured at the coulter connection.

3. The coulter holder according to claim 2, wherein the pivot bearing arranged at the frame connection is mounted movably in a bearing guide, in particular movably transversely to the pivot axis, in particular movably between an upper stop and a lower stop of the bearing guide.

4. The coulter holder according to claim 1, wherein the locking mechanism has at least one locking lever pivotable about a locking axis.

5. The coulter holder according to claim 4, wherein the locking lever is connected on one side of the locking axis via a lever bearing to the pivot bearing arranged on the frame connection and has a locking element on the other side of the locking axis.

6. The coulter holder according to one of claim 4, wherein a locking force acting on the locking element can be applied via the actuating element.

7. The coulter holder according to claim 4, wherein the locking element is hook-shaped and can be locked on a locking bolt arranged on the coulter connection.

8. The coulter holder according to claim 7, wherein in the working position, the locking bolt is supported by a stop of a supporting bearing configured at the frame connection in order to absorb forces applied via the coulter unit.

9. The coulter holder according to claim 1, wherein the frame connection and the coulter connection each have a mounting region for detachable mounting on the machine frame and/or of the coulter unit.

10. The coulter holder according to claim 9, wherein the pivot axis is arranged at an end of the coulter connection opposite the mounting region and the pivot bearing is arranged between the pivot axis and the mounting region.

11. The coulter holder according to claim 9, wherein the mounting region of the frame connection is configured complementary to a mounting region of the machine frame and the mounting region of the coulter connection is configured complementary to a mounting region of the coulter unit.

12. The coulter holder according to claim 1, wherein a weight force acting on the coulter-connection-side end of the actuating element in the working position is greater than a lever force acting on the frame-connection-side end of the actuating element.

13. A sowing machine having a machine frame and a plurality of coulter units arranged transversely to a running direction parallel to one another, at least one of the coulter units being attached to the machine frame via a coulter holder, wherein the coulter holder is configured according to claim 1.

14. The sowing machine according to claim 13, wherein several coulter units arranged transversely to the running direction parallel to each other, which are alternatingly attached directly to the machine frame or indirectly to the machine frame via a coulter holder.
